(19) United States
(12) Patent Application Publication
(10) Pub. No.: US 2007/0074590 A1
(43) Pub. Date: Apr. 5, 2007

(54) METHOD AND SYSTEM TO DETECT MALFUNCTIONS IN AN IONTOPHORESIS DEVICE THAT DELIVERS ACTIVE AGENTS TO BIOLOGICAL INTERFACES

(75) Inventor: Gregory A. Smith, Union City, CA (US)

Correspondence Address: SEED INTELLECTUAL PROPERTY LAW GROUP PLLC, 701 FIFTH AVE, SUITE 5400, SEATTLE, WA, 98104, US

(73) Assignee: Transcutaneous Technologies Inc., Tokyo (JP)

(21) Appl. No.: 11/534,972

(22) Filed: Sep. 25, 2006

Related U.S. Application Data
(60) Provisional application No. 60/722,187, filed on Sep. 30, 2005.

(51) Int. Cl. G01D 7/02

(52) U.S. Cl. 73/866.1; 604/20; 128/898

(57) ABSTRACT

An active agent delivery device is operable to deliver an active agent such as a drug or therapeutic agent to a biological interface such as skin or mucous membrane. The device, such as an iontophoresis device, may include one or more human-perceptible indicators operable to provide an indication of a malfunction or other defective condition of the device. Detectors may be provided to detect a value of a characteristic or parameter associated with one or more components of the device, with the value being usable to determine whether a defective condition may exist.

### CROSS REFERENCE TO RELATED APPLICATION

The present application claims the benefit of and priority under 35 U.S.C. § 119(e) of U.S. Provisional Patent Application Ser. No. 60/722,187, entitled “METHOD AND SYSTEM TO DETECT MALFUNCTIONS IN AN IONTOPHORESIS DEVICE THAT DELIVERS ACTIVE AGENTS TO BIOLOGICAL INTERFACES,” filed Sep. 30, 2005, assigned to the same assignee as the present application, and incorporated herein by reference in its entirety.

### TECHNICAL FIELD

This disclosure generally relates to the field of iontophoresis, and more particularly to the delivery of active agents such as therapeutic agents or drugs to a biological interface under the influence of electromotive force.

### BACKGROUND INFORMATION

Iontophoresis employs an electromotive force to transfer an active agent such as an ionic drug or other therapeutic agent to a biological interface, for example skin or mucus membrane.

Iontophoresis devices typically include an active electrode assembly and a counter electrode assembly, each coupled to opposite poles or terminals of a power source, for example a chemical battery. Each electrode assembly typically includes a respective electrode element to apply an electromotive force. Such electrode elements often comprise a sacrificial element or compound, for example silver or silver chloride.

The active agent may be either cation or anion, and the power source can be configured to apply the appropriate polarity based on the polarity of the active agent iontophoresis may be advantageously used to enhance or control the delivery rate of the active agent. As discussed in U.S. Pat. No. 5,395,310, the active agent may be stored in a reservoir such as a cavity. Alternatively, the active agent may be stored in a reservoir such as a porous structure or a gel. Also as discussed in U.S. Pat. No. 5,395,310, an ion exchange membrane may be positioned to serve as a polarity selective barrier between the active agent reservoir and the biological interface.

Commercial acceptance of iontophoresis devices is dependent on a variety of factors, such as reliable operation, cost to manufacture, shelf life or stability during storage, efficiency and/or timeliness of active agent delivery, biological capability, disposal issues, user comfort, and/or factors. However, existing iontophoresis devices can be unsatisfactory with respect to one or more of these factors.

### BRIEF SUMMARY

One aspect provides a method usable with an iontophoresis device that delivers an active agent to a biological interface. The method includes detecting a value of a characteristic associated with at least one component of the iontophoresis device. The detected value of the characteristic is evaluated to determine whether the detected value is indicative of a possible defective condition of the iontophoresis device. If the evaluated value is determined to be indicative of the possible defective condition, at least one human-perceptible indication that is indicative of the possible defective condition of the iontophoresis device is generated, including providing the human-perceptible indication in a manner that is perceivable from an exterior of the iontophoresis device.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a block diagram of an iontophoresis device comprising active and counter electrode assemblies according to one illustrated embodiment where the active electrode assembly includes an outermost membrane caching an active agent, an active agent adhered to an outer surface of the outermost membrane, and a removable outer release liner overlying or covering the active agent and outermost membrane.

FIG. 2 is a block diagram of the iontophoresis device of FIG. 1 positioned on a biological interface, with the outer release liner removed to expose the active agent according to one illustrated embodiment.

FIG. 3 is a block diagram of an iontophoresis device having a control unit integrated therewith.

FIG. 4 is a block diagram of an iontophoresis device having a first embodiment of a control unit that can detect and provide an indication of a malfunction of the iontophoresis device.

FIG. 5 is a block diagram of an iontophoresis device having a second embodiment of a control unit that can detect and provide an indication of a malfunction of the iontophoresis device.

FIG. 6 is a block diagram of an iontophoresis device having a third embodiment of a control unit that can detect and provide an indication of a malfunction of the iontophoresis device.

FIG. 7 is a flowchart of an embodiment of a technique to detect, evaluate, and provide an indication of a malfunction of an iontophoresis device.

### DETAILED DESCRIPTION

As an overview, an embodiment provides an iontophoresis device with circuitry or other features and functionality that provides an indication of whether or not the iontophoresis device is operating properly. There may be a number of reasons as to why the iontophoresis device is not operating properly. For example, one or more electrodes may not be properly placed against the biological interface, the integrity of the iontophoresis device may have been compromised (such as a manufacturing defect, damage while in storage or transport, mistreatment, or other malfunction), the useful life of one or more components may have elapsed, and/or other reasons. The useful life of the components may have lapsed prematurely, for example, due to a manufacturing defect or mishandling during use. Examples of elapsed useful life of one or more components can include, but not be limited to, drained power supply, dehydrated membranes, neutralization and/or reduction of useful ionic concentrations due to leakage that has caused ions to react or bind with one another, neutralization and/or reduction of required charges due to leakage that has caused charges to cancel each other out, premature depletion of sacrificial electrode elements, or other abnormal condition.

Determining that the iontophoresis device is not functioning properly can be useful for a number of reasons. For example, medical supply entities can manage inventory and ensure that they are dispensing operational products to patients and companies. As another example, patients and/or health care professionals can monitor the status of the iontophoresis device to ensure that active agents are in fact being delivered by the iontophoresis device. Clearly, there are medical risks at worst or inconveniences at least, if a patient and/or health care professional erroneously believes that an active agent is being delivered when in fact nothing is being delivered, or delivery is either at a reduced or at an elevated rate.

In an embodiment, a visual, audio, tactile, and/or other type of indicator can be provided to the user to indicate that the device is operating properly and/or not operating properly. Examples of such types of indicators are described below, along with circuitry or other features or functionality that support the operation of the indicator(s).

In an embodiment, the indicator(s) can provide their indication in response to information that is sensed by one or more sensors. For example, voltage and/or current sensors can be used to sense parameters of the iontophoresis device that may be indicative of a malfunction. Data provided by these sensors can be compared with threshold levels or otherwise processed to determine whether the indicator(s) should be activated to indicate a malfunction.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with controllers including but not limited to voltage and/or current regulators have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used herein and in the claims, the term “membrane” means a layer, barrier or material, which may, or may not be permeable. Unless specified otherwise, membranes may take the form a solid, liquid or gel, and may or may not have a distinct lattice or cross-linked structure.

As used herein and in the claims, the term “ion selective membrane” means a membrane that is substantially selective to ions, passing certain ions while blocking passage of other ions. An ion selective membrane for example, may take the form of a charge selective membrane, or may take the form of a semi-permeable membrane.

As used herein and in the claims, the term “charge selective membrane” means a membrane that substantially passes and/or substantially blocks ions based primarily on the polarity or charge carried by the ion. Charge selective membranes are typically referred to as ion exchange membranes, and these terms are used interchangeably herein and in the claims. Charge selective or ion exchange membranes may take the form of a cation exchange membrane, an anion exchange membrane, and/or a bipolar membrane. Examples of commercially available cation exchange membranes include those available under the designators NEOSEPTA, CM-1, CM-2, CMX, CMS, and CMB from Tokuyama Co., Ltd. Examples of commercially available anion exchange membranes include those available under the designators NEOSEPTA, AM-1, AM-3, AMX, AHA, ACH and ACS also from Tokuyama Co., Ltd.

As used herein and in the claims, the term bipolar membrane means a membrane that is selective to two different charges or polarities. Unless specified otherwise, a bipolar membrane may take the form of a unitary membrane structure or multiple membrane structure. The unitary membrane structure may having a first portion including cation ion exchange material or groups and a second portion opposed to the first portion, including anion ion exchange material or groups. The multiple membrane structure (e.g., two film) may be formed by a cation exchange membrane attached or coupled to an anion exchange membrane. The cation and anion exchange membranes initially start as distinct structures, and may or may not retain their distinctiveness in the structure of the resulting bipolar membrane.

As used herein and in the claims, the term “semi-permeable membrane” means a membrane that substantially selective based on a size or molecular weight of the ion. Thus, a semi-permeable membrane substantially passes ions of a first molecular weight or size, while substantially blocking passage of ions of a second molecular weight or size, greater than the first molecular weight or size.

As used herein and in the claims, the term “porous membrane” means a membrane that is not substantially selective with respect to ions at issue. For example, a porous membrane is one that is not substantially selective based on polarity, and not substantially selective based on the molecular weight or size of a subject element or compound.

A used herein and in the claims, the term “reservoir” means any form of mechanism to retain an element or compound in a liquid state, solid state, gaseous state, mixed state and/or transitional state. For example, unless specified otherwise, a reservoir may include one or more cavities formed by a structure, and may include one or more ion exchange membranes, semi-permeable membranes, porous membranes and/or gels if such are capable of at least temporarily retaining an element or compound.

The headings provided herein are for convenience only and do not interpret the scope or meaning of the embodiments.

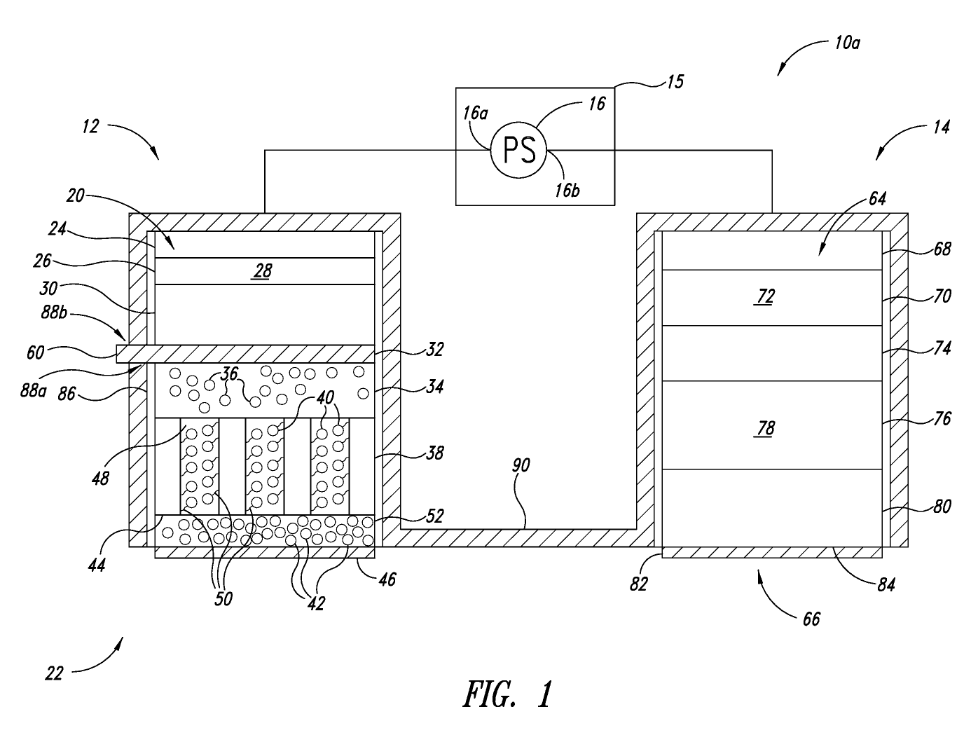

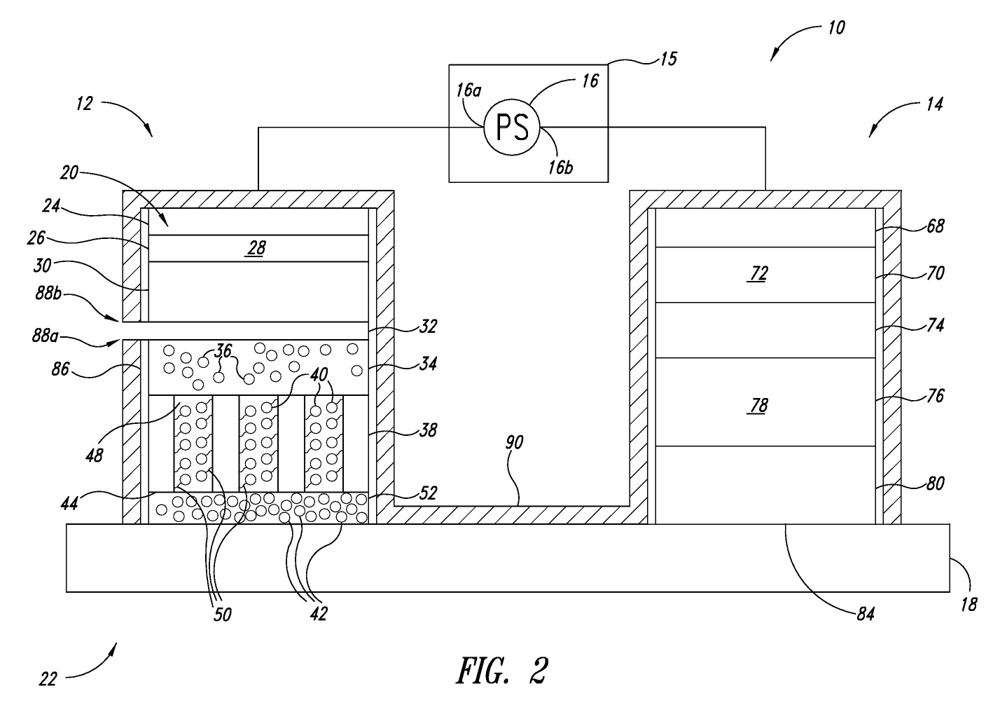

FIGS. 1 and 2 show an iontophoresis device 10 comprising active and counter electrode assemblies 12 and 14, respectively, electrically coupled to a control unit 15 having a power source 16, operable to supply an active agent to a biological interface 18 (see, e.g., FIG. 2), such as a portion of skin or mucous membrane via iontophoresis, according to one illustrated embodiment. Further details of embodiments of the control unit 15 will be described in further detail below.

In one example embodiment, the active electrode assembly 12 comprises, from an interior 20 to an exterior 22 of the active electrode assembly 12, an active electrode element 24, an electrolyte reservoir 26 storing an electrolyte 28, an inner ion selective membrane 30, an inner sealing liner 32, an inner active agent reservoir 34 storing active agent 36, an outermost ion selective membrane 38 that caches additional active agent 40, further active agent 42 carried by an outer surface 44 of the outermost ion selective membrane 38, and an outer release liner 46. Each of the above elements or structures will be discussed in detail below.

The active electrode element 24 is coupled to a first pole 16a of the power source 16 and positioned in the active electrode assembly 12 in a manner that an electromotive force or current can be applied to transport active agent 36, 40, 42 via various other components of the active electrode assembly 12. The active electrode element 24 may take a variety of forms. For example, the active electrode element 24 may include a sacrificial element, for example a chemical compound or amalgam including silver (Ag) or silver chloride (AgCI). Such compounds or amalgams typically employ one or more heavy metals, for example lead (Pb), which may present issues with regard manufacturing, storage, use and/or disposal. Consequently, some embodiments may advantageously employ a carbon-based active electrode element 24. Such may, for example, comprise multiple layers, for example a polymer matrix comprising carbon and a conductive sheet comprising carbon fiber or carbon fiber paper, such as that described in commonly assigned pending Japanese patent application 2004/317317, filed Oct. 29, 2004.

In use, the outermost active electrode ion selective membrane 38 may be placed directly in contact with the biological interface 18 (see, e.g., FIG. 2). Alternatively, an interface-coupling medium (not shown) may be employed between the outermost active electrode ion selective membrane 38 and the biological interface 18. The interface-coupling medium may, for example, take the form of an adhesive and/or gel. The gel may, for example, take the form of a hydrating gel or a hydrogel. If used, the interface-coupling medium can be permeable by any one or more of the active agents 36, 40, 42.

The electrolyte reservoir 26 may take a variety of forms including any structure capable of retaining electrolyte 28, and in some embodiments may even be the electrolyte 28 itself, for example, where the electrolyte 28 is in a gel, semi-solid or solid form. For example, the electrolyte reservoir 26 may take the form of a pouch or other receptacle, a membrane with pores, cavities or interstices, such as where the electrolyte 28 is a liquid.

The electrolyte 28 may provide ions or donate charges to prevent or inhibit the formation of gas bubbles (e.g., hydrogen) on the active electrode element 24 in order to enhance efficiency and/or increase delivery rates. This elimination or reduction in electrolysis may in turn inhibit or reduce the formation of acids and/or bases (e.g., H⁺ ions, OH⁻ ions), that would otherwise present possible disadvantages such as reduced efficiency, reduced transfer rate, and/or possible irritation of the biological interface 18. As discussed further below, in some embodiments the electrolyte 28 may provide or donate ions to substitute for the active agent, for example substituting for the active agent 40 cached thereon. Such may facilitate transfer of the active agent 40 to the biological interface 18, for example, increasing and/or stabilizing delivery rates. A suitable electrolyte may take the form of a solution of 0.5M disodium fumarate: 0.5M Poly acrylic acid (5:1).

The inner ion selective membrane 30 is generally positioned to separate the electrolyte 28 and the inner active agent reservoir 34. The inner ion selective membrane 30 may take the form of a charge selective membrane. For example, where the active agent 36, 40, 42 comprises a cationic active agent, the inner ion selective membrane 38 may take the form of an anion exchange membrane, selective to substantially pass anions and substantially block cations. Also, for example, where the active agent 36, 40, 42 comprises an anionic active agent, the inner ion selective membrane 38 may take the form of an cationic exchange membrane, selective to substantially pass cations and substantially block anions. The inner ion selective membrane 38 may advantageously prevent transfer of undesirable elements or compounds between the electrolyte 28 and the active agents 26, 40, 42. For example, the inner ion selective membrane 38 may prevent or inhibit the transfer of hydrogen (H⁺) or sodium (Na⁺) ions from the electrolyte 72, which may increase the transfer rate and/or biological compatibility of the iontophoresis device 10.

The inner sealing liner 32 separates the active agent 36, 40, 42 from the electrolyte 28 and is selectively removable, as discussed in detail below with respect to FIG. 2. The inner sealing liner 32 may advantageously prevent migration or diffusion between the active agent 36, 40, 42 and the electrolyte 28, for example, during storage or other situations.

The inner active agent reservoir 34 is generally positioned between the inner ion selective membrane 30 and the outermost ion selective membrane 38. The inner active agent reservoir 34 may take a variety of forms including any structure capable of temporarily retaining active agent 36, and in some embodiments may even be the active agent 36 itself, for example, where the active agent 36 is in a gel, semi-solid or solid form. For example, the inner active agent reservoir 34 may take the form of a pouch or other receptacle, a membrane with pores, cavities or interstices, particularly where the active agent 36 is a liquid. The inner active agent reservoir 34 may advantageously allow larger doses of the active agent 36 to be loaded in the active electrode assembly 12.

The outermost ion selective membrane 38 is positioned generally opposed across the active electrode assembly 12 from the active electrode element 24. The outermost membrane 38 may, as in the embodiment illustrated in FIGS. 1 and 2, take the form of an ion exchange membrane, pores 48 (only one called out in FIGS. 1 and 2 for sake of clarity of illustration) of the ion selective membrane 38 including ion exchange material or groups 50 (only three called out in FIGS. 1 and 2 for sake of clarity of illustration). Under the influence of an electromotive force or current, the ion exchange material or groups 50 selectively substantially passes ions of the same polarity as active agent 36, 40, while substantially blocking ions of the opposite polarity. Thus, the outermost ion exchange membrane 38 is charge selective. Where the active agent 36, 40, 42 is a cation (e.g., lidocaine), the outermost ion selective membrane 38 may take the form of a cation exchange membrane. Alternatively, where the active agent 36, 40, 42 is an anion, the outermost ion selective membrane 38 may take the form of an anion exchange membrane.

The outermost ion selective membrane 38 may advantageously cache active agent 40. In particular, the ion exchange groups or material 50 temporarily retains ions of the same polarity as the polarity of the active agent in the absence of electromotive force or current and substantially releases those ions when replaced with substitutive ions of like polarity or charge under the influence of an electromotive force or current.

Alternatively, the outermost ion selective membrane 38 may take the form of semi-permeable or microporous membrane which is selective by size. In some embodiments, such a semi-permeable membrane may advantageously cache active agent 40, for example by employing the removably releasable outer release liner 46 to retain the active agent 40 until the outer release liner 46 is removed prior to use.

The outermost ion selective membrane 38 may be preloaded with the additional active agent 40, such as ionized or ionizable drugs or therapeutic agents and/or polarized or polarizable drugs as the therapeutic agents. Where the outermost ion selective membrane 38 is an ion exchange membrane, a substantial amount of active agent 40 may bond to ion exchange groups 50 in the pores, cavities or interstices 48 of the outermost ion selective membrane 38.

The active agent 42 that fails to bond to the ion exchange groups of material 50 may adhere to the outer surface 44 of the outermost ion selective membrane 38 as the further active agent 42. Alternatively, or additionally, the further active agent 42 may be positively deposited on and/or adhered to at least a portion of the outer surface 44 of the outermost ion selective membrane 38, for example, by spraying, flooding, coating, electrostatically, vapor deposition, and/or otherwise. In some embodiments, the further active agent 42 may sufficiently cover the outer surface 44 and/or be of sufficient thickness so as to form a distinct layer 52. In other embodiments, the further active agent 42 may not be sufficient in volume, thickness or coverage as to constitute a layer in a conventional sense of such term.

The active agent 42 may be deposited in a variety of highly concentrated forms such as, for example, solid form, nearly saturated solution form or gel form. If in solid form, a source of hydration may be provided, either integrated into the active electrode assembly 12, or applied from the exterior thereof just prior to use.

In some embodiments, the active agent 36, additional active agent 40, and/or further active agent 42 may be identical or similar compositions or elements. In other embodiments, the active agent 36, additional active agent 40, and/or further active agent 42 may be different compositions or elements from one another. Thus, a first type of active agent may be stored in the inner active agent reservoir 34, while a second type of active agent may be cached in the outermost ion selective membrane 38. In such an embodiment, either the first type or the second type of active agent may be deposited on the outer surface 44 of the outermost ion selective membrane 38 as the further active agent 42. Alternatively, a mix of the first and the second types of active agent may be deposited on the outer surface 44 of the outermost ion selective membrane 38 as the further active agent 42. As a further alternative, a third type of active agent composition or element may be deposited on the outer surface 44 of the outermost ion selective membrane 38 as the further active agent 42. In another embodiment, a first type of active agent may be stored in the inner active agent reservoir 34 as the active agent 36 and cached in the outermost ion selective membrane 38 as the additional active agent 40, while a second type of active agent may be deposited on the outer surface 44 of the outermost ion selective membrane 38 as the further active agent 42. Typically, in embodiments where one or more different active agents are employed, the active agents 36, 40, 42 can all be of common polarity to prevent the active agents 36, 40, 42 from competing with one another. Other combinations are possible.

The outer release liner 46 may generally be positioned overlying or covering further active agent 42 carried by the outer surface 44 of the outermost ion selective membrane 38. The outer release liner 46 may protect the further active agent 42 and/or outermost ion selective membrane 38 during storage, prior to application of an electromotive force or current. The outer release liner 46 may be a selectively releasable liner made of waterproof material, such as release liners commonly associated with pressure sensitive adhesives. Note that the inner release liner 46 is shown in place in FIG. 1 and removed in FIG. 2.

The counter electrode assembly 14 allows completion of an electrical path between poles 16a, 16b of the power source 16 via the active electrode assembly 12 and the biological interface 18. The counter electrode assembly 14 may take a variety of forms suitable for closing the circuit by providing a return path.

In the embodiment illustrated in FIGS. 1 and 2, the counter electrode assembly comprises, in order to from an interior 64 to an exterior 66 of the counter electrode assembly 14: a counter electrode element 68, electrolyte reservoir 70 storing an electrolyte 72, an inner ion selective membrane 74, an optional buffer reservoir 76 storing buffer material 78, an outermost ion selective membrane 80, and an outer release liner 82.

The counter electrode element 68 is electrically coupled to a second pole 16b of the power source 16, the second pole 16b having an opposite polarity to the first pole 16a. The counter electrode element 68 may take a variety of forms. For example, the counter electrode element 68 may include a sacrificial element, such as a chemical compound or amalgam including silver (Ag) or silver chloride (AgCI), or may include a non-sacrificial element such as the carbon-based electrode element discussed above.

The electrolyte reservoir 70 may take a variety of forms including any structure capable of retaining electrolyte 72, and in some embodiments may even be the electrolyte 72 itself, for example, where the electrolyte 72 is in a gel, semi-solid or solid form. For example, the electrolyte reservoir 70 may take the form of a pouch or other receptacle, or a membrane with pores, cavities or interstices, particularly where the electrolyte 72 is a liquid.

The electrolyte 72 is generally positioned between the counter electrode element 68 and the outermost ion selective membrane 80, proximate the counter electrode element 68. The electrolyte 72 may provide ions or donate charges to prevent or inhibit the formation of gas bubbles (e.g., hydrogen) on the counter electrode element 68 and may prevent or inhibit the formation of acids or bases or neutralize the same, which may enhance efficiency and/or reduce the potential for irritation of the biological interface 18.

The inner ion selective membrane 74 is positioned between and/or to separate, the electrolyte 72 from the buffer material 78. The inner ion selective membrane 74 may take the form of a charge selective membrane, such as the illustrated ion exchange membrane that substantially allows passage of ions of a first polarity or charge while substantially blocking passage of ions or charge of a second, opposite polarity. The inner ion selective membrane 74 will typically pass ions of opposite polarity or charge to those passed by the outermost ion selective membrane 80 while substantially blocking ions of like polarity or charge. Alternatively, the inner ion selective membrane 74 may take the form of a semi-permeable or microporous membrane that is selective based on size.

The inner ion selective membrane 74 may prevent transfer of undesirable elements or compounds into the buffer material 78. For example, the inner ion selective membrane 74 may prevent or inhibit the transfer of hydrogen (H⁺) or sodium (Na⁺) ions from the electrolyte 72 into the buffer material 78.

The optional buffer reservoir 76 is generally disposed between the electrolyte reservoir and the outermost ion selective membrane 80. The buffer reservoir 76 may take a variety of forms capable of temporarily retaining the buffer material 78. For example, the buffer reservoir 76 may take the form of a cavity, a porous membrane or a gel.

The buffer material 78 may supply ions for transfer through the outermost ion selective membrane 42 to the biological interface 18. Consequently, the buffer material 78 may, for example, comprise a salt (e.g., NaCI).

The outermost ion selective membrane 80 of the counter electrode assembly 14 may take a variety of forms. For example, the outermost ion selective membrane 80 may take the form of a charge selective ion exchange membrane, such as a cation exchange membrane or an anion exchange membrane, which substantially passes and/or blocks ions based on the charge carried by the ion. Examples of suitable ion exchange membranes are discussed above. Alternatively, the outermost ion selective membrane 80 may take the form of a semi-permeable membrane that substantially passes and/or blocks ions based on size or molecular weight of the ion.

The outermost ion selective membrane 80 of the counter electrode assembly 14 is selective to ions with a charge or polarity opposite to that of the outermost ion selective membrane 38 of the active electrode assembly 12. Thus, for example, where the outermost ion selective membrane 38 of the active electrode assembly 12 allows passage of negatively charged ions of the active agent 36,40, 42 to the biological interface 18, the outermost ion selective membrane 80 of the counter electrode assembly 14 allows passage of positively charged ions to the biological interface 18, while substantially blocking passage of ions having a negative charge or polarity. On the other hand, where the outermost ion selective membrane 38 of the active electrode assembly 12 allows passage of positively charged ions of the active agent 36, 40, 42 to the biological interface 18, the outermost ion selective membrane 80 of the counter electrode assembly 14 allows passage of negatively charged ions to the biological interface 18 while substantially blocking passage of ions with a positive charge or polarity.

The outer release liner 82 may generally be positioned overlying or covering an outer surface 84 of the outermost ion selective membrane 80. Note that the inner release liner 82 is shown in place in FIG. 1 and removed in FIG. 2. The outer release liner 82 may protect the outermost ion selective membrane 80 during storage, prior to application of an electromotive force or current. The outer release liner 82 may be a selectively releasable liner made of waterproof material, such as release liners commonly associated with pressure sensitive adhesives. In some embodiments, the outer release liner 82 may be coextensive with the outer release liner 46 of the active electrode assembly 12.

The power source 16 may take the form of one or more chemical battery cells, super- or ultra-capacitors, or fuel cells. The power source 16 may, for example, provide a voltage of 12.8V DC, with tolerance of 0.8V DC, and a current of 0.3 mA. The power source 16 may be selectively electrically coupled to the active and counter electrode assemblies 12,14 via a control circuit in the control unit 15, for example, via carbon fiber ribbons. The control unit 15 of the iontophoresis device 10 may include discrete and/or integrated circuit elements to control the voltage, current and/or power delivered to the electrode assemblies 12, 14. For example, the iontophoresis device 10a may include a diode to provide a constant current to the electrode elements 20, 68 and/or may include other elements so as to generate a current output to transfer any one or more of the active agent 36, 40,42 to the biological interface 18. Embodiments of the control unit 15 that further provide features for detecting malfunction in the iontophoresis device 10 and for providing an indicator to notify the user of a malfunction will be described later below.

As suggested above, the active agent 36, 40, 42 may take the form of a cationic or an anionic drug or other therapeutic agent. Consequently, the terminals or poles 16a, 16b of the power source 16 may be reversed. Likewise, the selectivity of the outermost ion selective membranes 38, 80 and inner ion selective membranes 30, 74 may be reversed.

The iontophoresis device 10 may further comprise an inert molding material 86 adjacent exposed sides of the various other structures forming the active and counter electrode assemblies 12,14. The molding material 86 may advantageously provide environmental protection to the various structures of the active and counter electrode assemblies 12,14. Molding material 86 may form a slot or opening 88a on one of the exposed sides through which the tab 60 extends to allow for the removal of inner sealing liner 32 prior to use. Enveloping the active and counter electrode assemblies 12,14 is a housing material 90. The housing material 90 may also form a slot or opening 88b positioned aligned with the slot or opening 88a in molding material 86 through which the tab 60 extends to allow for the removal of inner sealing liner 32 prior to use of the iontophoresis device 10.

Immediately prior to use, the iontophoresis device 10 is prepared by withdrawing the inner sealing liner 32 and removing the outer release liners 46, 82. As described above, the inner sealing liner 32 may be withdrawn by pulling on tab 60. The outer release liners 46, 82 may be pulled off in a similar fashion to remove release liners from pressure sensitive labels and the like.

As best seen in FIG. 2, the active and counter electrode assemblies 12,14 are positioned on the biological interface 18. Positioning on the biological interface may close the circuit, allowing electromotive force to be applied and/or current to flow from one pole 16a of the power source 16 to the other pole 16b, via the active electrode assembly, biological interface 18 and counter electrode assembly 14.

In the presence of the electromotive force and/or current, active agent 36 is transported toward the biological interface 18. Additional active agent 40 is released by the ion exchange groups or material 50 by the substitution of ions of the same charge or polarity (e.g., active agent 36), and transported toward the biological interface 18. While some of the active agent 36 may substitute for the additional active agent 40, some of the active agent 36 may be transferred through the outermost ion elective membrane 38 into the biological interface 18. Further active agent 42 carried by the outer surface 44 of the outermost ion elective membrane 38 is also transferred to the biological interface 18.

During iontophoresis, the electromotive force across the electrode assemblies, as described, leads to a migration of charged active agent molecules, as well as ions and other charged components, through the biological interface 18 into the biological tissue. This migration may lead to an accumulation of active agents, ions, and/or other charged components within the biological tissue beyond the interface. During iontophoresis, in addition to the migration of charged molecules in response to repulsive forces, there is also an electroosmotic flow of solvent (e.g., water) through the electrodes and the biological interface into the tissue. In certain embodiments, the electroosmotic solvent flow enhances migration of both charged and uncharged molecules. Enhanced migration via electroosmotic solvent flow may occur particularly with increasing size of the molecule.

In the embodiments of FIGS. 1-2, the control unit 15 is depicted as being coupled externally of the housing material 90. Such embodiments may be implemented, for example, in situations where the electrode assemblies 12 and 14 of the iontophoresis device 10 is coupled to an external computer system, control system, or other system or device. For example, the electrode assemblies 12 and 14 may be present on a portable device, such as a probe, that is in remote communication (wireless and/or wired) with the control unit 15. The control unit 15 can in turn remotely supply power and control signals, as well as receive feedback data or other data from the electrode assemblies 12 and 14.

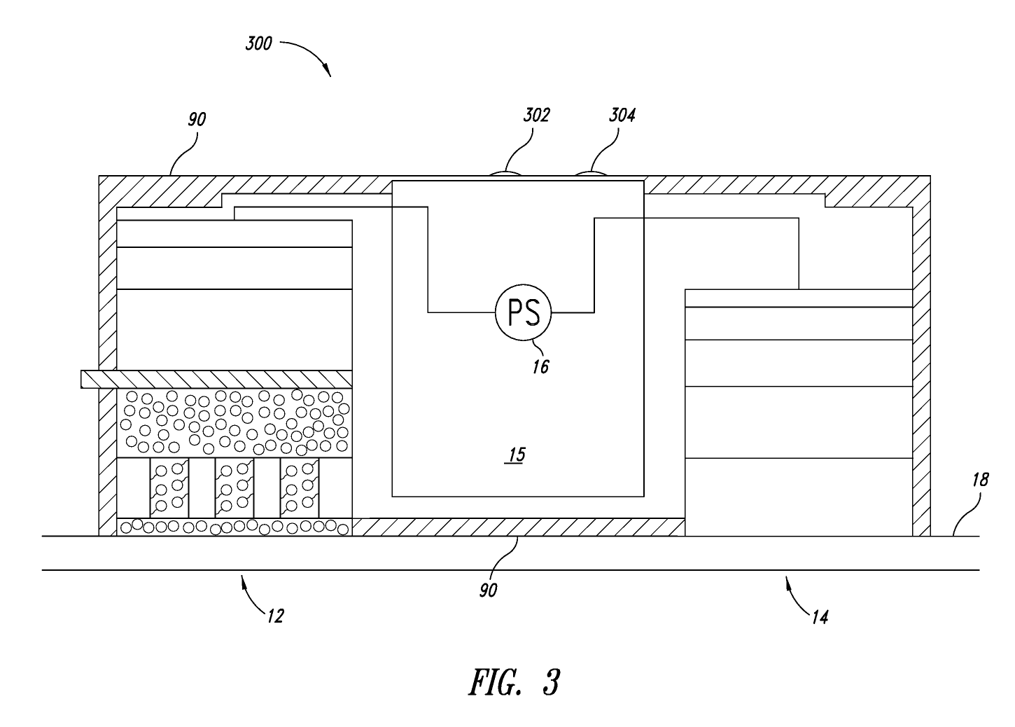

In other embodiments, the control unit 15 can be integrated with or otherwise included with the electrode assemblies 12 and 14 in a common housing material 90. An example of such an embodiment is shown in FIG. 3.

In FIG. 3, an iontophoresis device 300 has generally similar components as those previously shown and described with respect to the iontophoresis device 10 of FIGS. 1-2. One difference is that the control unit 15 in the embodiment of the iontophoresis device 300 of FIG. 3 is encapsulated within the housing material 90 along with the electrode assemblies 12 and 14. Thus, a self-contained unit is provided which need not use or may minimally use an accompanying external system for control, power, processing, etc.

An embodiment of the control unit 15 can be implemented as using an integrated circuit, circuit board, or other device or assembly of devices. The control unit 15 may be positioned within the housing material 90 between the electrode assemblies 12 and 14, so as to make efficient use of space and real estate on the iontophoresis device 300.

In an embodiment, the housing material 90 may have one or more apertures 302. The aperture 302 serves as an interface through which the user of the iontophoresis device 300 can observe one or more indications that indicate an operative state of the iontophoresis device 300 (e.g., whether or not the iontophoresis device 300 is malfunctioning). Thus, such one or more indicators (such as human-perceptible indicators) can be perceivable externally from or at an exterior of the iontophoresis device 300.

In one embodiment, the aperture 302 comprises a sealed transparent, semi-translucent, or translucent opening (such as an opening sealed with clear plastic) in the housing material 90 through which a visual indication (such as a particular color of light from an LED) can indicate whether the iontophoresis device 300 is malfunctioning. Alternatively or additionally, the aperture 302 can comprise a speaker opening through which audio or aural indications of malfunctions can be provided. Yet still alternatively or additionally, the aperture 302 can comprise a material that effectively transmits a tactile indication (such as a vibration) that indicates a malfunction or lack of malfunction of the iontophoresis device 300. Various example configurations of the control unit 15 that can generate these indications will be described in detail later below.

In one embodiment, a keypad, button, or other user input device 304 may also be coupled to the housing material 90. The user input device 304 can be used, for example, to turn the iontophoresis device ON or OFF, enter configuration settings for the control unit 14, enter threshold values or other values that can be correlated with detected values to determine if the iontophoresis device 300 is malfunctioning, program software (if present) in the iontophoresis device 300, and other operations to interact with the iontophoresis device 300.

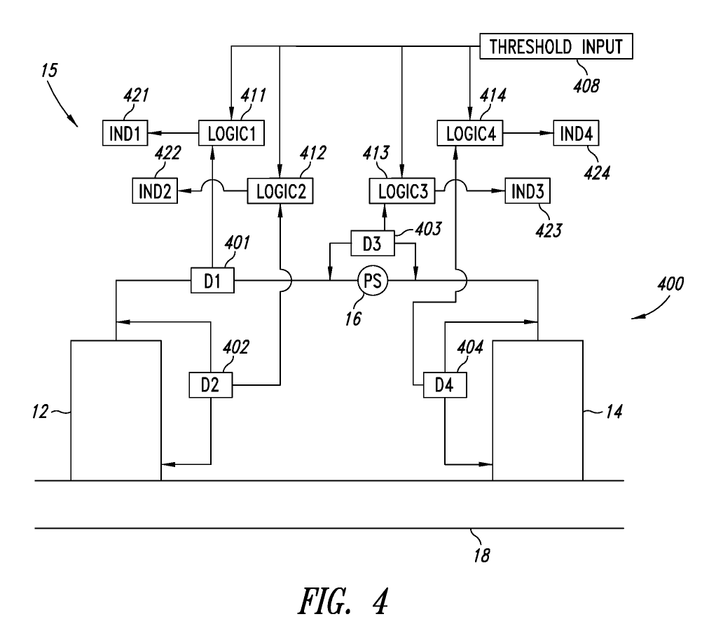

FIG. 4 illustrates an embodiment of the control unit 15 for an iontophoresis device 400 having electrode assemblies 12 and 14 similar to those previously described. Various embodiments of the iontophoresis device 400 (and various embodiments of the control unit 15) or other embodiments of the iontophoresis devices described herein may also be implemented with electrode assemblies different than the specific electrode assemblies 12 and 14 that were previously described. For example, such different electrode assemblies may have a different configuration of components and/or may have a fewer or a greater number of components than those shown with regards to the previously described electrode assemblies 12 and 14.

In FIG. 4, the iontophoresis device 400 is illustrated as being placed on the biological interface 18 so as to detect a malfunction, such as if the electrode assemblies 12 and 14 are not in good conductive contact with the surface of the biological interface 18. It is appreciated that embodiments of the control unit 15 to detect other types of malfunctions do not necessarily require the iontophoresis device 400 to be physically placed on the biological interface 18.

The various embodiments of the control unit 15 that detect defective conditions, evaluate the defective conditions, and provide indications that represent the defective conditions can be implemented within a self-contained unit, such as shown and described with reference to FIG. 3. Alternatively or additionally, some components of the control unit 15 that detect, evaluate, and provide indications may be present in an external system.

The embodiment of the control unit 15 in FIG. 4 includes a plurality of detectors 401-404 to detect a characteristic associated with certain components of the iontophoresis device 400. Such characteristics can comprise, for instance, voltage across one or more components, current flowing through one or more components, power output, impedance such as resistance, and so on. The number and type of detector to implement may vary from one embodiment to another. For example, in some embodiments of the control unit 15, there may only be one detector to detect, for example, just the current flow through the electrode assemblies 12 and 14. In still other embodiments, there may be additional detectors other than those explicitly shown in the example of FIG. 4. In yet other embodiments, redundant detectors may be present to serve as backup detectors and/or to detect other characteristics.

A first detector 401 can comprise a current detector to detect a value of a current flowing from the power source 16 to the active electrode assembly 12. A low value of current detected by the first detector 401 can be indicative of, for example, increased impedance that may be caused by poor conduction between and/or improper placement of one or both of the electrode assemblies 12 and 14 on the biological interface 18. The poor conduction can be caused, for instance, if residue from the outer release liner 46 is still present and inhibiting ionic flow.

Increased impedance may also be indicative of a loose conductive connection between the power supply 16 and one (or both) of the electrode assemblies 12 and 14. Increased impedance may also be further indicative of poor ionic flow or charge transfer through the various membranes of the active electronic assembly 12, which may be due to a number of abnormal factors, such as neutralized ions, faulty membranes, low active agent concentration, and others.

A high detected current value can be indicative of a short circuit somewhere in the iontophoresis device 10. The first detector 401 can include a fuse or other element to protect the first detector 401 against exceedingly large current flow.

A second detector 402 can comprise a voltage detector to detect voltage across one or more or all layers of the active electrode assembly 12. A high or increase in detected voltage value can be indicative of, for example, increased impedance. As discussed above, increased impedance can be indicative of improper electrode placement, a defect, or other malfunction. Conversely, a low detected voltage can be indicative of a short circuit somewhere in the iontophoresis device 400.

In an embodiment, the conductive probes of the second detector 402 can be inserted into the appropriate layers of the active electrode assembly 12 during the manufacturing stage, if the voltage across a particular section of layers is desired for monitoring. In another embodiment where the voltage across all layers is desired, one probe of the second detector 402 can be conductively coupled to the terminal 16a, while another probe of the second detector 402 can be placed on a surface of the active electrode assembly 12 that makes contact with the biological interface 18.

Alternatively or additionally to a voltage detector, the second detector 402 can comprise ion-specific electrodes or similar device that can provide an indication of a salt concentration, acid level, concentration of a particular type of ion, hydration, and the like. The output of the ion-specific electrodes may be evaluated to determine, for example, whether a type of ion or other substance is present, and if so, the concentration of that ion. The detected level of the concentration can be compared with expected levels for normal operation, including correlation with time parameters if appropriate, to determine whether there is a malfunction or defect. An abnormally high or an abnormally low concentration of an ion may be indicative of, for instance, depleted or neutralized ions due to manufacturing defects or mishandling, premature depletion of sacrificial electrode elements, excessive or in adequate current flow, and so forth.

A third detector 403 can be provided to detect a characteristic of the power supply 16. An example of the third detector 403 is a voltage detector to detect voltage across the power supply 16 so as to determine whether there is a malfunction with the power supply 16. For instance, a low detected voltage may be indicative of a depleted or otherwise defective or malfunctioning power supply 16. Other examples of the third detector 403 (or of the various other detectors) can comprise a current detector, an impedance detector such as an ohmmeter, a power detector, and so on.

In one embodiment of the iontophoresis device 400, a fourth detector 404 can be provided to detect a characteristic in the counter electrode assembly 14, alternatively or additionally to the second detector 402 that detects a characteristic of the active electrode assembly 12. An example of the fourth detector 404 is a voltage detector to detect a voltage across one or more or all layers of the counter electrode assembly 14.

In an embodiment, each of the detectors 401-404 is respectively coupled to respective evaluation circuits 411-414, or at least some of the detectors 401-404 may share common evaluation circuits. The evaluation circuits 411-414 respectively receive output data, from the detectors 401-404, representative of the detected characteristics.

The evaluation circuits 411-414 of an embodiment can comprise logic circuits, such as depicted in FIG. 4. Such logic circuits can compare, for example, values of the received output data with stored values to determine whether a defective condition exists. For instance, the logic circuits can include comparators that compare whether a value of received output data is higher or lower than the stored value.

In one embodiment, the stored values can be hard-coded or otherwise set or configured for each of the evaluation circuits 411-414 during manufacture. In another embodiment, the stored values can be input from an input unit 408. The input unit 408 may be used by the user and/or manufacturer to provide threshold values or other values that can be compared with detected values. The input unit 408 can comprise a keypad, button, or other user input device, such as the user input device 304 of FIG. 3 that is coupled to the housing material 90.

The evaluation circuits 411-414 of an embodiment can include circuitry (such as samplers, analog-to-digital converters, or other devices) to obtain a discrete value from analog outputs of the detectors 401-404, if the detectors 401-404 provide analog outputs. The circuitry allows the analog outputs to be converted to discrete values that can be utilized by the evaluation circuits 411-414, if the evaluation circuits 411-414 comprise digital circuitry. Alternatively or additionally, the evaluation circuits 411-414 can comprise analog circuitry, such that analog outputs of the detectors 401-404 need not be converted, or the evaluation circuits 411-414 can include digital-to-analog converters or the like to convert digital outputs of the detectors 401-404 to analog form, if the detectors 401-404 generate digital outputs.

In an embodiment, each of the evaluation circuits 411-414 is respectively coupled to indicators 421-424. The indicators 421-424 respectively receive outputs from the evaluation circuits 411-414, with the outputs from the evaluation circuits 411-414 being indicative of whether or not there is a malfunction. In one embodiment, the evaluation circuits 411-414 only provide an output if there is a defective condition and do not provide an output otherwise. In another embodiment, a default output of the evaluation circuits 411-414 is indicative of non-defective conditions, and then the default output is changed if a defective condition is determined to be present. Thus, based on the particular embodiment or combination thereof used, the indicators 421-424 can provide no output until a defective condition is detected (e.g., an OFF LED indicator turns ON when a defective condition is detected), or the indicators 421-424 change their output when a defective condition is detected (e.g., an continuously ON LED turns from green to red).

The indicators 421-424 can be implemented using a variety of different devices that have different states that are indicative of respective different conditions. Moreover, it is possible to provide embodiments where there is a combination of different types of indicators 421-424, such as a combination of audio, visual, tactile, etc. indicators.

For visual indication, the indicators 421-424 can include, but not be limited to, LEDs (including LEDs of different colors), flashing lights, incandescent light bulbs or other types of light bulbs, liquid crystal displays that provide a visual output that may include text and/or graphics that present status information, mechanical indicators such as a meter having a pointer that moves from one position to another position, an electrochemical indicator such as PH paper that changes from one color to another color in response to a chemical reaction induced by an electrical signal, devices that secrete ink, and/or other types of visual indicators that would be familiar to a person skilled in the art having the benefit of this disclosure.

In one embodiment, a visual indicator is selectively controllable and can, for example, comprise a LED that emits light when forward biased. Alternatively, the visual indicator can comprise a liquid crystal display, as stated above, that passes or reflects light when its crystals are properly aligned. The visual indicator can alternatively take the form of an electro-luminescent display that produces a light output in response to a voltage or current. Alternatively, the visual indicator can take the form of an electro-chromic display, capable of producing a variety of colors in response to a voltage or current.

Alternatively or additionally, the indicators 421-424 can comprise audible indicators. Examples of audible indicators include, but are not limited to, buzzers, beepers, tones, rings, playback of recorded human voices (such as a recorded “Check Power Supply” voice recording), playback of machine-generated messages, music, user-customized or user-selectable audio indicators (somewhat similar to user-selectable ring tones for cell phones), or other audible indication. If appropriate, the indicators 421-424 can use or include amplifiers, speakers, filters, and other devices to enhance or otherwise improve the quality of the audio.

In one embodiment, an audible indicator comprises a membrane that can be vibrated to produce an audible and/or tactile signal, and which is coupled to the power source 16 or other power source so as to be selectively provided with power to vibrate the membrane. Furthermore as an example, the audible indicator may issue a tone if there is a detected malfunction, while remaining silent in the while no malfunction is detected, or can issue different tones or number of tones based on the state of the iontophoresis device 400. Volume levels can also correspond to different status conditions.

Alternatively or additionally to devices that produce visually human-perceptible and/or audibly human-perceptible outputs, the indicators 421-424 can comprise tactile indicators or similar devices that can produce outputs that can be felt by the user. Examples include, but are not limited to, vibrating devices, pulsating devices, devices that change temperature in response to an input signal (e.g., going from ambient room temperature to a hotter temperature), devices that use a vibrating membrane driven by a piezoelectric element or by an electrostatic element, devices that inflict a mild electric shock or mild pain, or any other device that can produce a human-perceptible tactile output.

In an embodiment, a tactile indicator can include a membrane that can be made to vibrate by varying applied voltages. Like charges will cause the membrane to move outward, while unlike charges will tend to cause the membrane to move inward. The charges can be varied at a frequency sufficient to produce sound within the human hearing range. Additionally or alternatively, the frequency can be such that the vibration may be felt as a tactile sensation.

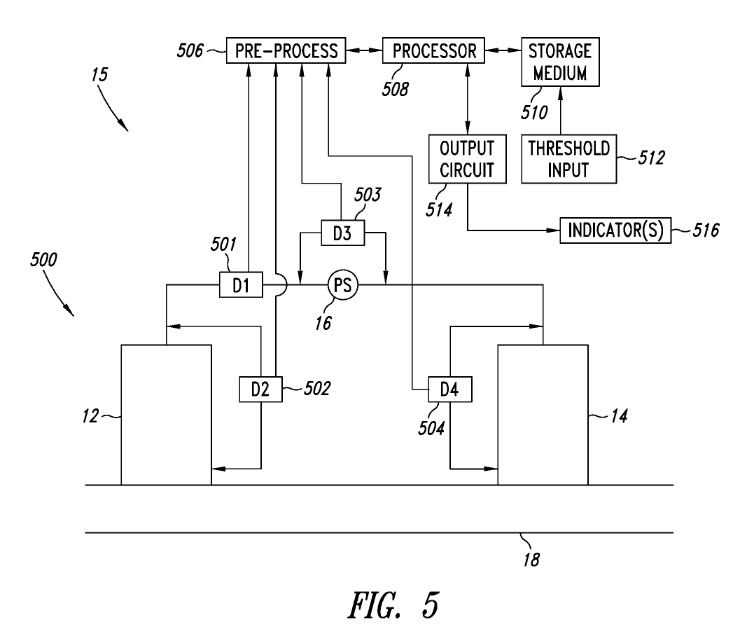

FIG. 5 is a block diagram of another embodiment of the control unit 15 for an iontophoresis device 500. In comparison to the embodiment of the control unit in FIG. 4 that uses evaluation circuits, the embodiment of the control unit 15 in FIG. 5 uses a processor and software to evaluate detected values.

The control unit 15 of FIG. 5 comprises one or more detectors 501-504, which can be similar to the detectors 401-404 described above with reference to FIG. 4. Each of the detectors 501-504 generates an output that is provided to a pre-processing unit 506. For example, the pre-processing unit 506 can include samplers, rectifiers, analog-to-digital converters, or other devices that can prepare the outputs of the detectors 501-504 for a processor 508 that is coupled to the pre-processing unit 506.

The processor 508 is coupled to a machine-readable storage medium 510, which stores software or other machine-readable instructions that are executable by the processor 508. For example, the software can cooperate with the processor 508 to evaluate the outputs of the detectors 501-504 to determine whether there is a malfunction of the iontophoresis device 10. This evaluation can comprise, in one embodiment, using an algorithm to compare the output values of the detectors 501-504 with expected values for normal operation and/or with stored values that classify a condition as being a malfunction. Such comparisons can include comparisons with threshold values or other values provided by an input unit 512.

The input unit 512 can comprise buttons, a keypad, or other component that can provide reference values or otherwise program the software stored in the storage medium 510. The user input device 304 of FIG. 3 can be one possible implementation of the user input unit 512.

The processor 508 is coupled to one or more indicators 516, which provide an indication that is indicative of a condition of the iontophoresis device 500, such as whether or not there is a malfunction. The indicator(s) 516 can comprise similar indicators as those described previously with respect to FIG. 4, such as various audible, visual, and/or tactile indicators.

In an embodiment, an output circuit 514 can be coupled between the processor 508 and the indicator(s) 516. For example, the output circuit 514 can comprise converters, drivers, logic circuits, or other components that condition or otherwise prepare output signals from the processor 508 for the indicator(s) 516.

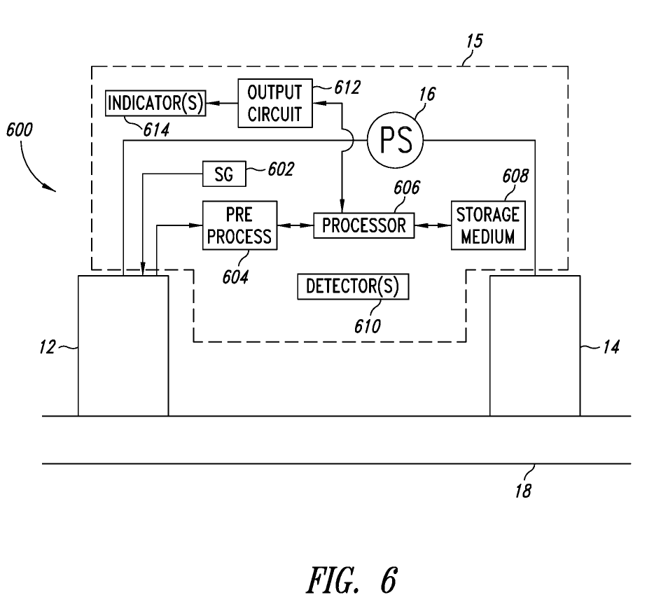

FIG. 6 shows yet another embodiment of the control unit 15 for an iontophoresis device 600. In the embodiment of FIG. 6, the control unit 15 uses an electromechanical impedance spectroscopy (EIS) technique to determine whether there is a malfunction in the active electrode assembly 12 and/or in the counter electrode assembly 14.

EIS involves an application of a sinusoidal electrochemical perturbation (such as potential or current waveform) to a sample that covers a wide range of frequencies. This multi-frequency excitation allows: (1) the measurement of several electrochemical reactions that take place at very different rates, and (2) the measurement of the capacitance of the electrode.

In an embodiment, the control unit 15 includes a signal generator 602 to apply a sinusoidal or other waveform shape to one or both of the electrode assemblies 12 and 14. Return signals from this excitation are received by a pre-processing circuit 604, which is coupled to a processor 606. The processor 606 is in turn coupled to one or more machine-readable storage media 608 that stores software or other machine-readable instructions executable by the processor 606.

The stored software can comprise, for example, EIS software that evaluates the return signals to determine the type and extent of various reactions that can be tied to impedance, including measurements of capacitance or other characteristics. The software can further cooperate with the processor 606 to determine if the results of the EIS are indicative of any particular defect or malfunction in the electrode assemblies 12 or 14. In an embodiment, input data (such as threshold data or other programming) can be provided for the software by way of a user input device (not shown) similar to those previously described in FIGS. 3-5.

The control unit 15 of FIG. 6 can further comprise one or more indicators 614 to provide indications of whether there is malfunction of the iontophoresis device 600, and an output circuit 612 coupled between the indicators 614 and the processor 606 to condition outputs of the processor 606 for the indicators 614.

The type of indicators 614 that can be implemented for the embodiment of FIG. 6 may be similar to the indicators that have been previously described. In an embodiment, the control unit 15 of FIG. 6 can further include one or more additional detectors 610 in addition to having EIS capability, with the detectors 610 being similar to the detectors that have been previously described. For the sake of brevity, details of the indicators and detectors are not repeated herein.

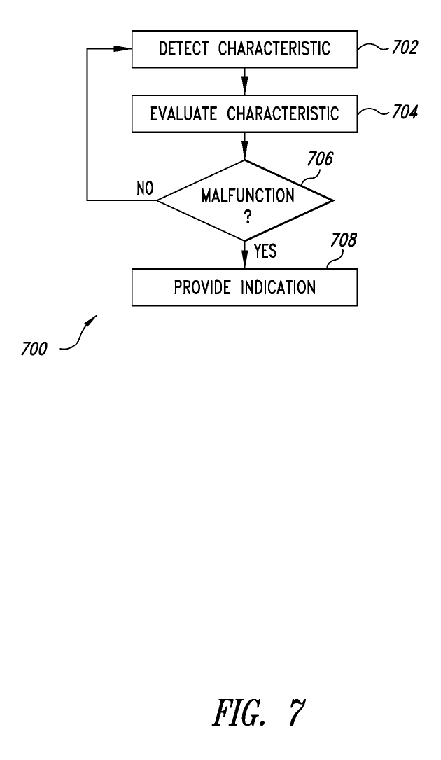

FIG. 7 is a flowchart 700 of a technique to detect, evaluate, and provide indications of characteristics of an iontophoresis device that has control units such as those previously described above. The technique shown in FIG. 7 can be performed in a self-contained unit that includes the iontophoresis device and/or performed in a system that may be external to the iontophoresis device. In one embodiment, the operations shown in the flowchart 700 can be implemented by software or other machine-readable instruction stored on a machine-readable storage medium and executable by a processor, such as the storage media and processors that have been previously shown and described. The operations shown in the flowchart 700 need not necessarily occur in the exact order shown, and various operations can be added, removed, changed, or combined.

At a block 702, one or more characteristics of one or more components of the iontophoresis device are detected. As described above, the detected characteristics can comprise detected values representative of current, voltage, impedance, capacitance, inductance, or other parameter that can be associated with proper/improper operation of the iontophoresis device.

At a block 702, the values of the detected characteristics are evaluated. For example circuitry and/or a processor using software can compare the values with stored values to determine if certain thresholds have been met, not met, or exceeded, including evaluation of the detected characteristics in view of time parameters. For example, a detected voltage may be higher than an expected voltage value for a particular time interval during the iontophoretic process, which therefore is indicative of a high resistance that may be caused poor electrode placement, damage, or other defective condition.

If a malfunction or other defective condition is determined to possibly exist at a block 706, then an indication is provided at a block 708. The provided indication can be any one or combination of audible, visual, or tactile indication.

In certain embodiments, the active agent may be a higher molecular weight molecule. In certain aspects, the molecule may be a polar polyelectrolyte. In certain other aspects, the molecule may be lipophilic. In certain embodiments, such molecules may be charged, may have a low net charge, or may be uncharged under the conditions within the active electrode. In certain aspects, such active agents may migrate poorly under the iontophoretic repulsive forces, in contrast to the migration of small more highly charged active agents under the influence of these forces. These higher molecular active agents may thus be carried through the biological interface into the underlying tissues primarily via electroosmotic solvent flow. In certain embodiments, the high molecular weight polyelectrolytic active agents may be proteins, polypeptides or nucleic acids.

The above description of illustrated embodiments, including what is described in the Abstract, is not intended to be exhaustive or to limit the claims to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other agent delivery systems and devices, not necessarily the exemplary iontophoresis active agent system and devices generally described above. For instance, while some embodiments may include all of the membranes, reservoirs and other structures discussed above, other embodiments may omit some of the membranes, reservoirs or other structures, or may include additional structures. For example, some embodiment may include a control circuit or subsystem to control a voltage, current, or power applied to the active and counter electrode elements 20, 40. Also for example, some embodiments may include an interface layer interposed between the outermost active electrode ion selective membrane 22 and the biological interface 18. Some embodiments may comprise additional ion selective membranes, ion exchange membranes, semi-permeable membranes and/or porous membranes, as well as additional reservoirs for electrolytes and/or buffers.

Various electrically conductive hydrogels have been known and used in the medical field to provide an electrical interface to the skin of a subject or within a device to couple electrical stimulus into the subject. Hydrogels hydrate the skin, thus protecting against burning due to electrical stimulation through the hydrogel, while swelling the skin and allowing more efficient transfer of an active component. Examples of such hydrogels are disclosed in U.S. Pat. Nos. 6,803,420; 6,576,712; 6,908,681; 6,596,401; 6,329,488; 6,197,324; 5,290,585; 6,797,276; 5,800,685; 5,660,178; 5,573,668; 5,536,768; 5,489,624; 5,362,420; 5,338,490; and 5,240995, herein incorporated in their entirety by reference. Further examples of such hydrogels are disclosed in U.S. Patent Application Publication Nos. 2004/166147; 2004/105834; and 2004/247655, herein incorporated in their entirety by reference. Product brand names of various hydrogels and hydrogel sheets include Corplex™ by Corium, Tegagel™ by 3M, PuraMatrix™ by BD; Vigilon™ by Bard; ClearSite™ by Conmed Corporation; FlexiGel™ by Smith & Nephew; Derma-Gel™ by Medline; Nu-Gel™ by Johnson & Johnson; and Curagel™ by Kendall, or acrylhydrogel films available from Sun Contact Lens Co., Ltd.

The various embodiments discussed above may advantageously employ various microstructures, for example microneedles. Microneedles and microneedle arrays, their manufacture, and use have been described. Microneedles, either individually or in arrays, may be hollow; solid and permeable; solid and semi-permeable; or solid and non-permeable. Solid, non-permeable microneedles may further comprise grooves along their outer surfaces. Microneedle arrays, comprising a plurality of microneedles, may be arranged in a variety of configurations, for example rectangular or circular. Microneedles and microneedle arrays may be manufactured from a variety of materials, including silicon; silicon dioxide; molded plastic materials, including biodegradable or non-biodegradable polymers; ceramics; and metals. Microneedles, either individually or in arrays, may be used to dispense or sample fluids through the hollow apertures, through the solid permeable or semi-permeable materials, or via the external grooves. Microneedle devices are used, for example, to deliver a variety of compounds and compositions to the living body via a biological interface, such as skin or mucous membrane. In certain embodiments, the active agent compounds and compositions may be delivered into or through the biological interface. For example, in delivering compounds or compositions via the skin, the length of the microneedle(s), either individually or in arrays, and/or the depth of insertion may be used to control whether administration of a compound or composition is only into the epidermis, through the epidermis to the dermis, or subcutaneous. In certain embodiments, microneedle devices may be useful for delivery of high-molecular weight active agents, such as those comprising proteins, peptides and/or nucleic acids, and corresponding compositions thereof. In certain embodiments, for example wherein the fluid is an ionic solution, microneedle(s) or microneedle array(s) can provide electrical continuity between a power source and the tip of the microneedle(s). Microneedle(s) or microneedle array(s) may be used advantageously to deliver or sample compounds or compositions by iontophoretic methods, as disclosed herein. In certain embodiments, for example, a plurality of microneedles in an array may advantageously be formed on an outermost biological interface-contacting surface of an iontophoresis device. Compounds or compositions delivered or sampled by such a device may comprise, for example, high-molecular weight active agents, such as proteins, peptides and/or nucleic acids.

In certain embodiments, compounds or compositions can be delivered by an iontophoresis device comprising an active electrode assembly and a counter electrode assembly, electrically coupled to a power source to deliver an active agent to, into, or through a biological interface. The active electrode assembly includes the following: a first electrode member connected to a positive electrode of the power source; an active agent reservoir having an active agent solution that is in contact with the first electrode member and to which is applied a voltage and/or current via the first electrode member; a biological interface contact member, which may be a microneedle array and is placed against the forward surface of the active agent reservoir; and a first cover or container that accommodates these members. The counter electrode assembly includes the following: a second electrode member connected to a negative electrode of the power source; an electrolyte reservoir that holds an electrolyte that is in contact with the second electrode member and to which voltage and/or current is applied via the second electrode member; and a second cover or container that accommodates these members.

In certain other embodiments, compounds or compositions can be delivered by an iontophoresis device comprising an active electrode assembly and a counter electrode assembly, electrically coupled to a power source to deliver an active agent to, into, or through a biological interface. The active electrode assembly includes the following: a first electrode member connected to a positive electrode of the power source; a first electrolyte reservoir having an electrolyte that is in contact with the first electrode member and to which is applied a voltage and/or current via the first electrode member; a first anion exchange membrane that is placed on the forward surface of the first electrolyte reservoir; an active agent reservoir that is placed against the forward surface of the first anion exchange membrane; a biological interface contacting member, which may be a microneedle array and is placed against the forward surface of the active agent reservoir; and a first cover or container that accommodates these members. The counter electrode assembly includes the following: a second electrode member connected to a negative electrode of the power source; a second electrolyte reservoir having an electrolyte that is in contact with the second electrode member and to which is applied a voltage and/or current via the second electrode member; a cation exchange membrane that is placed on the forward surface of the second electrolyte reservoir; a third electrolyte reservoir that is placed against the forward surface of the cation exchange membrane and holds an electrolyte to which a voltage and/or current is applied from the second electrode member via the second electrolyte reservoir and the cation exchange membrane; a second anion exchange membrane placed against the forward surface of the third electrolyte reservoir; and a second cover or container that accommodates these members.

Certain details of microneedle devices, their use and manufacture, are disclosed in U.S. Pat. Nos. 6,256,533; 6,312,612; 6,334,856; 6,379,324; 6,451,240; 6,471,903; 6,503,231; 6,511,463; 6,533,949; 6,565,532; 6,603,987; 6,611,707; 6,663,820; 6,767,341; 6,790,372; 6,815,360; 6,881,203; 6,908,453; 6,939,311; all of which are incorporated herein by reference in their entirety. Some or all of the teaching therein may be applied to microneedle devices, their manufacture, and their use in iontophoretic applications.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety, including but not limited to: Japanese Patent Application Serial No. H03-86002, filed Mar. 27,1991, having Japanese Publication No. H04-297277, issued on Mar. 3, 2000 as Japanese Patent No. 3040517; Japanese Patent Application Serial No.11-033076, filed Feb. 10,1999, having Japanese Publication No. 2000-229128; Japanese Patent Application Serial No. 11-033765, filed Feb. 12,1999, having Japanese Publication No. 2000-229129; Japanese Patent Application Serial No. 11-041415, filed Feb. 19,1999, having Japanese Publication No. 2000-237326; Japanese Patent Application Serial No. 11-041416, filed Feb. 19,1999, having Japanese Publication No. 2000-237327; Japanese Patent Application Serial No. 11-042752, filed Feb. 22,1999, having Japanese Publication No. 2000-237328; Japanese Patent Application Serial No. 11-042753, filed Feb. 22,1999, having Japanese Publication No. 2000-237329; Japanese Patent Application Serial No. 11-099008, filed Apr. 6,1999, having Japanese Publication No. 2000-288098; Japanese Patent Application Serial No. 11-099009, filed Apr. 6,1999, having Japanese Publication No. 2000-288097; PCT Patent Application WO 2002JP4696, filed May 15, 2002, having PCT Publication No. WO03037425; U.S. patent application Ser. No. 10/488,970, filed Mar. 9, 2004; Japanese Patent Application 2004/317317, filed Oct. 29, 2004; U.S. Provisional Patent Application Ser. No. 60/627,952, filed Nov. 16, 2004; Japanese Patent Application Serial No. 2004-347814, filed Nov. 30, 2004; Japanese Patent Application Serial No. 2004-357313, filed Dec. 9, 2004; Japanese Patent Application Serial No. 2005-027748, filed Feb. 3, 2005; Japanese Patent Application Serial No. 2005-081220, filed Mar. 22, 2005; and U.S. Provisional Patent Application Ser. No. 60/754,953, filed Dec. 28, 2005.

Aspects of the various embodiments can be modified, if necessary, to employ systems, circuits and concepts of the various patents, applications and publications to provide yet further embodiments. While some embodiments may include all of the membranes, reservoirs and other structures discussed above, other embodiments may omit some of the membranes, reservoirs or other structures. Still other embodiments may employ additional ones of the membranes, reservoirs and structures generally described above. Even further embodiments may omit some of the membranes, reservoirs and structures described above while employing additional ones of the membranes, reservoirs and structures generally described above.

These and other changes can be made in light of the above-detailed description. In general, in the following claims, the terms used should not be construed to be limiting to the specific embodiments disclosed in the specification and the claims, but should be construed to include all systems, devices and/or methods that operate in accordance with the claims. Accordingly, the invention is not limited by the disclosure, but instead its scope is to be determined entirely by the following claims.

What is claimed is:

1. A method usable with an iontophoresis device that delivers an active agent to a biological interface, the method comprising:
detecting a value of a characteristic associated with at least one component of the iontophoresis device;
evaluating the detected value of the characteristic to determine whether the detected value is indicative of a possible defective condition of the iontophoresis device; and
if the evaluated value is determined to be indicative of the possible defective condition, generating at least one human-perceptible indication that is indicative of the possible defective condition of the iontophoresis device, including providing the human-perceptible indication in a manner that is perceivable from an exterior of the iontophoresis device.

2. The method of claim 1 wherein detecting the value of the characteristic comprises detecting a value of one or combination of a current, voltage, power, impedance, capacitance, inductance, and impedance spectrum.

3. The method of claim 1 wherein evaluating the detected value includes comparing the detected value with a stored value representing a threshold.

4. The method of claim 1 wherein generating at least one-human perceptible indication includes generating a visual indication.

5. The method of claim 1 wherein generating at least one-human perceptible indication includes generating an audible indication.

6. The method of claim 1 wherein generating at least one-human perceptible indication includes generating a tactile indication.

7. The method of claim 1 wherein the possible defective condition includes improper placement of the iontophoresis device on the biological interface.

8. The method of claim 1 wherein the possible defective condition includes a damage or improper operation of at least one component of the iontophoresis device.

9. An article of manufacture, comprising:
a machine-readable medium usable with an iontophoresis device and having instructions stored thereon that are executable by a processor to determine whether a possible defective condition of the iontophoresis device exists, by:
evaluating a detected value of a characteristic associated with operation of the iontophoresis device to determine whether the detected value is indicative of the possible defective condition; and
initiating generation of at least one human-perceptible indication that is indicative of the possible defective condition of the iontophoresis device, if the evaluated value is determined to be indicative of the possible defective condition.

10. The article of manufacture of claim 9 wherein the instructions to initiate generation of at least one-human perceptible indication includes instructions to provide the human-perceptible indication in a manner that is perceivable from an exterior of the iontophoresis device.

11. The article of manufacture of claim 9 wherein the machine-readable medium is located within a common housing material as the iontophoresis device.

12. The article of manufacture of claim 9 wherein the machine-readable medium further includes instructions executable by the processor to determine whether the possible defective condition exists, by:
applying an impedance spectroscopy technique to at least one component of the iontophoresis device; and
obtaining the detected value of the characteristic, which is to be evaluated, from results from the applied impedance spectroscopy technique.

13. The article of manufacture of claim 9 wherein the machine-readable medium further includes instructions executable by the processor to determine whether the possible defective condition exists, by:
controlling at least one detector to obtain the value of the characteristic.

14. A system, comprising:
iontophoresis device means for delivering an active agent to a biological interface;
detector means for obtaining a value of a parameter associated with operation of at least one component of the iontophoresis device means;
evaluation means for evaluating the obtained value of the parameter to determine whether there may be a possible malfunction of the iontophoresis device means; and
indicator means for providing, based on the evaluated value of the parameter, a human-perceptible indication of whether the possible malfunction of the iontophoresis device means may exist.

15. The system of claim 14 wherein the evaluation means includes circuit means for comparing the value of the parameter with a reference value.

16. The system of claim 14 wherein the evaluation means includes processing means in cooperation with machine-readable instruction means for determining if the value of the parameter is indicative of the possible malfunction of the iontophoresis device means.

17. The system of claim 14 wherein the evaluating means is externally and separately located from the iontophoresis device means.

18. An iontophoresis device, comprising:
an active electrode assembly to deliver an active agent to a biological interface;
a power supply coupled to the active electrode assembly to apply a current to the active electrode assembly to induce delivery of the active agent to the biological interface;
a counter electrode assembly coupled to the power supply; and
a control unit coupled to the electrode assemblies and to the power supply, the control unit including:
at least one detector to detect a value of a characteristic associated with any one or combination of the electrode assemblies and the power supply;
an evaluation unit coupled to the detector to receive an input based on the detected value and to determine whether the input is indicative of a possible malfunction; and
an indicator coupled to the evaluation unit and responsive to the evaluation unit to provide a human-perceptible indication of the possible malfunction.

19. The device of claim 18 wherein the evaluation unit comprises circuitry coupled to compare the input with at least one specified value.

20. The device of claim 18 wherein the evaluation unit comprises a processor able to execute machine-readable instructions to determine whether the input is indicative of the possible malfunction.

21. The device of claim 18 wherein the indicator provides a graphical display output.

22. The device of claim 18, further comprising an input unit coupled to the evaluation unit to receive information pertaining to evaluation of the input to the evaluation unit.

23. The device of claim 18 wherein the indicator provides a visual indication that includes at least one or more of an optical indication, a mechanical indication, an electrochemical indication.

24. The device of claim 18 wherein the indicator provides an audible indication.

25. The device of claim 18 wherein the indicator provides an indication that can be sensed by user touching.

26. The device of claim 18 wherein said at least one detector includes a voltage detector to detect a voltage across at least one layer of one of said electrode assemblies.

27. The device of claim 18 wherein said at least one detector includes a current detector placed coupled between said electrode assemblies.

28. The device of claim 18 wherein said at least one detector includes a detector coupled to said power supply.
